(19) United States
(12) Patent Application Publication
(10) Pub. No.: US 2007/0078610 A1
(43) Pub. Date: Apr. 5, 2007

(54) System enabling remote analysis of fluids

(76) Inventors: Bruce W. Adams, Vancouver (CA); Peter R.H. McConnell, Vancouver (CA)

Correspondence Address: GOTTLIEB RACKMAN & REISMAN PC, 270 MADISON AVENUE, 8TH FLOOR, NEW YORK, NY, 100160601, US

(21) Appl. No.: 10/548,944

(22) PCT Filed: Mar. 15, 2004
(86) PCT No.: PCT/CA04/00387

§ 371 Date: Nov. 28, 2006

Related U.S. Application Data
(60) Provisional application No. 60/454,636, filed on Mar. 17, 2003.

(51) Int. Cl. G06F 19/00

(52) U.S. Cl. 702/28

(57) ABSTRACT

The present invention provides a system enabling the remote analysis of a fluid, wherein the analysis of the fluid and collection of data relating thereto can be provided at a plurality of remote locations by a plurality of remote devices. Each remote device is connected directly or indirectly to a central controller via one or more communication networks, thereby enabling centralised collection, evaluation and analysis of a plurality of data relating to characteristics of the fluid system being monitored. The system according to the present invention can further provide a means for the collection of strategic samples of fluid, for example, such that these samples can be collected from one or more of the remote locations at a later time for future and more detailed analysis at a laboratory or other facility. The fluid monitoring system provides a means for real time monitoring of a fluid at a plurality of locations together with a global view of the characteristics of a fluid system. In one embodiment of the invention, this fluid monitoring system can provide information and risk factors relating to real time change in the characteristics of a fluid and the fluid system.

### FIELD OF THE INVENTION

The present invention pertains to the field of fluid analysis and in particular to a system that enables the remote analysis of fluids.

### BACKGROUND

It is desirable that accurate sampling of fluids may be made and understood in the context of a man-made and natural fluid systems, such that an estimate of problems and potential problems may be fully understood, while allowing time and opportunity for appropriate action to be taken. The collection and analysis of fluids represents a method of evaluating the ever-changing natural and constructed environment, and has proven to be a useful way of understanding these systems. The types of fluids presently collected include, for example, fresh water, salt water, wastewater and air from the vicinity of industrial plants, coal fired hydro-electric plants, water purification plants, drinking water facilities and a variety of other areas as would be readily understood. These fluids can be tested for characteristics including turbidity, temperature, pH level, dissolved oxygen, agricultural run-off, phosphorous, nitrogen, metals, toxic organic compounds, fecal coliform and other contaminants which may cause problems.

Such fluid systems are often complex and large, and the monitoring of them is a difficult task. Currently, the analysis of fluids in remote locations requires a person to visit the site when a sample is required. The tester takes a sample, and can generally return with the sample to a central laboratory where the fluid is tested. Usually the tester can collect many samples from different locations on any one trip. Alternatively the tester may take a portable test unit along, and test the fluid at each location where the fluid is sampled. When the results of the tests are critical, the tester may use a cell phone or other means to relay the test results to a central location.

The use of a human retrieval system has a number of drawbacks. There is a financial cost for the time of the tester and method of travel, and with many of these sites being in remote locations, the use of vehicles or aircraft may be required. There will often be a delay between the sampling and the results of the tests being known if the samples need to be returned to the laboratory before being tested. Such delays can cause difficulties in alerting people to potential problems, and delays in the generation of an accurate model for the prediction of future values. Test samples may only be taken at significant intervals usually days or weeks. Such long intervals between tests can cause uncertainties and lack of confidence in the sample tests. For example, freak, unusual or incorrect samples may only be checked by a special trip to the test site. From time to time there may be spurious results; as such it would be useful to repeat such tests to double-check these strange results. Often a special situation will occur such as a weather storm or dam discharge for example, where tests are required immediately and frequently, in order to carefully monitor a potential problem situation. The use of a human retrieval system can have significant delay problems in such a case.

At the present time, measurements of fluids have focussed on the identification of problems at the individual points of measurement. There is a need to be able to understand the overall system and the interaction between the fluid flow and the levels of specific pollutants at the different sites. The human collection of these fluid samples has severely limited the generation of an overall model.

At specific times, there is a need for samples of the fluid to be quickly taken and retained. For example, after a heavy thunderstorm, there may be a need to take a sample of water, which may be analysed by a remote system, but may also be needed for further analysis or even as a proof of a pollution quality. Other examples include the discharge of waste material into a water system.

Limited devices are available for the remote analysis of fluids. U.S. Pat. No. 4,089,209 describes a remote water monitoring system, specifically for the collection of water samples using a floating buoy. The system has a radio link to a central location, whereby requests for samples to be taken may be made, water samples subsequently being taken and tested, and the results of the tests on these samples relayed back to the central location.

U.S. Pat. No. 4,009,078 describes an electroanalytic means of measuring microorganisms in a fluid sample. The method uses the changing potential between electrodes to provide an estimate of the microorganism content of a sample. Samples of fluid may be collected, tested, with this collected subsequently being discharged, such that the system is ready for a new sample to be taken.

The accurate and real-time monitoring of fluids can allow for policing of man made pollutants in fluids and the assessment of natural changes in the environment and their impact on fluid system, for example. Therefore there is a need for a system that enables the remote sampling and testing of fluids for a variety of different criteria, without the recalibration or modification of the testing system for each particular test required.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a system enabling remote analysis of fluids. In accordance with an aspect of the present invention, there is provided a system enabling remote analysis of a fluid, said fluid being collected from at least one source, said system comprising a plurality of remote devices capable of collecting and analyzing the fluid, each said remote device including a sample chamber for receiving and orienting the fluid for analysis, said sample chamber being in fluidic contact with one at least one source, a sensing system operatively associated with the sample chamber, said sensing system illuminating the fluid with an encoded illumination signal and collecting an illumination response; a signal processing system for controlling the sensing system, said signal processing system performing data analysis procedures for detecting and correlating the illumination response with the encoded illumination signal, thereby providing a means for determining a fluid spectral response to the illumination of the fluid; and a communication module enabling the remote device to transmit signals; a central controller for receiving signals from the plurality of remote devices, said signals including a plurality of fluid spectral responses, the central controller collecting the signals for subsequent analysis: and at least one communication network enabling transmission of signals between the plurality of remote devices and the central server.

### BRIEF DESCRIPTION OF THE FIGURES

FIG. 1 illustrates a distributed system according to one embodiment of the present invention, enabling the remote analysis of fluids, including a distributed network of remote devices interconnected to a central controller.

FIG. 2 illustrates a distributed system according to one embodiment of the present invention, wherein the system enables sampling and analysis of water within a public water system from an initial source.

FIG. 3 illustrates a remote device comprising an optical sensing system and a signal processing system according to one embodiment of the present invention.

FIG. 4 is a schematic of the signal processing system indicating the interconnectivity between the elements thereof, according to one embodiment of the present invention.

FIG. 5 illustrates the interrelationship between the key parameters affecting risk evaluation performed by the system, according to one embodiment of the present invention.

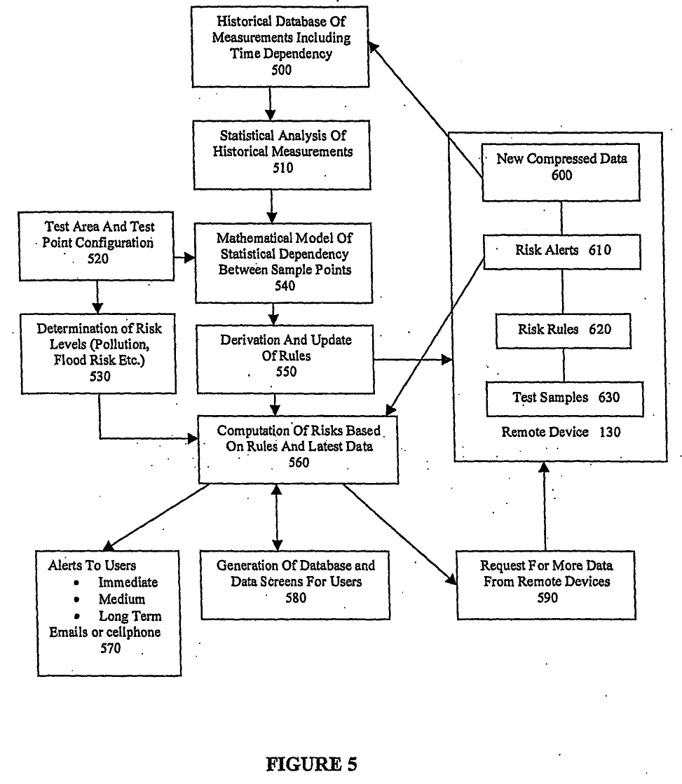

### DETAILED DESCRIPTION OF THE INVENTION

Definitions

The term “fluid” is used to define a plurality of substances that can be a liquid or a gas for example, water, oil, natural gas, air, propane and the like.

The term “communication network” is used to define a plurality of different communication mechanisms for example, wireless, wired, Ethernet, WAP, Bluetooth™, PSTN, satellite or any other type of communication mechanism as would be readily understood by a worker skilled in the art.

Unless defined otherwise, all technical and scientific terms used herein have the same meaning as commonly understood by one of ordinary skill in the art to which this invention belongs.

Overall Fluid Monitoring System

The present invention provides a system enabling the remote analysis of a fluid, wherein the analysis of the fluid and collection of data relating thereto can be provided at a plurality of remote locations by a plurality of remote devices. Each remote device is connected directly or indirectly to a central controller via one or more communication networks, thereby enabling centralised collection, evaluation and analysis of a plurality of data relating to characteristics of the fluid system being monitored. The system according to the present invention can further provide a means for the collection of strategic samples of fluid, for example, such that these samples can be collected from one or more of the remote locations at a later time for future and more detailed analysis at a laboratory or other facility. The fluid monitoring system provides a means for real time monitoring of a fluid at a plurality of locations together with a global view of the characteristics of a fluid system. In one embodiment of the invention, this fluid monitoring system can provide information and risk factors relating to real time change in the characteristics of a fluid and the fluid system.

The fluid monitoring system comprises a plurality of remote devices capable of performing a spectral analysis of a fluid or fluid sample in situ. A remote device illuminates a fluid sample with an encoded illumination signal and subsequently detects received light comprising information relating to the reaction of the fluid sample to this illumination. The reaction of the fluid sample to illumination can be in the form of reflectance and/or fluorescence. The correlation or matching performed between the received light and the encoded illumination enhances the detection of the test sample reaction, thereby providing a means for identifying the reflectance and/or fluorescence reaction of the fluid that may initially be indistinguishable from background noise within the system. For example, fluorescence is inherently lower in energy than reflectance and hence can be more difficult to detect in the presence of noise. The collection and identification of the reaction of a fluid sample to predetermined illumination can enable the determination of a spectral signature of the fluid sample or characteristics thereof. The fluid monitoring system can have a plurality of remote devices positioned within the fluid system, with each performing the functions of data collection and analysis. Each of these remote devices are interconnected to a central controller, thereby forming a network of data collection locations enabling the evaluation of one or more characteristics including possible contamination of a fluid within a fluid movement system and the location of this possible contamination, for example. The system can be used to evaluate characteristics of fluid systems including, for example, a water supply system, oil or gas pipeline or the like.

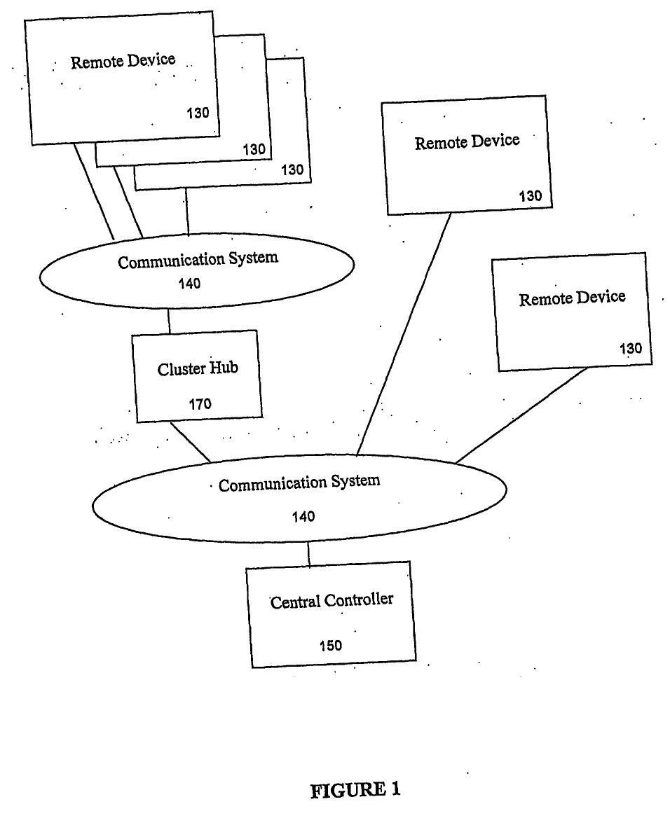

With reference to FIG. 1, a possible configuration of the fluid monitoring system is illustrated. The monitoring system comprises a plurality of remote devices 130, located a variety of locations. These remote devices are interconnected to the central controller 150 directly or indirectly through one or more communication networks 140. In one embodiment, a cluster hub 170 provides an intermediate location for information collection and/or analysis that may subsequently transmitted to the central controller. In this manner, the cluster hub provides a means for reducing demands on the central controller for receiving information or even being directly connected to remote devices in the vicinity of the cluster hub. The cluster hub is subsequently connected to the central controller by the same or alternate communication network. Remote devices are placed at strategic geographical points where fluid measurement and analysis is required. The remote units may be instructed to sample these fluids at defined times or may sample continuously or randomly, for example, subsequently relaying the results to the central controller directly or indirectly through one or more cluster hubs. A cluster hub can be used to evaluate and analyse data collected by the remote devices to which it is connected and subsequently transmit this analysed information to the central controller thereby reducing the volume of data evaluation to be performed by the central controller. Optionally, a cluster hub may only contact the central controller if requested to by the central controller or if a predetermined event occurs.

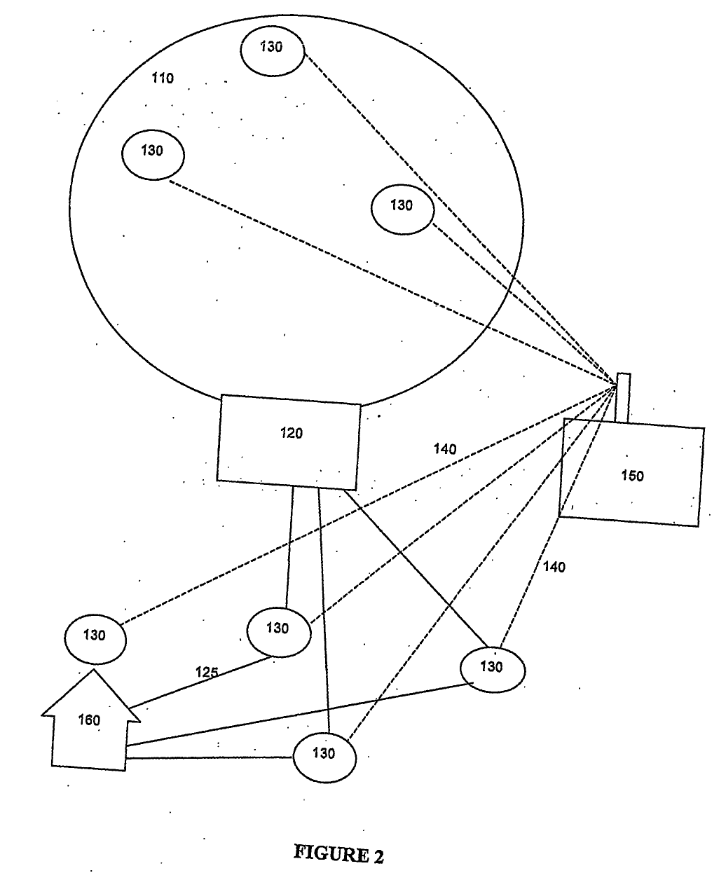

In one embodiment of the present invention, and with reference to FIG. 2, a schematic of the positioning of components of the fluid monitoring system is provided having direct regard to the monitoring of water within a public water system from a source. In FIG. 2, water from the watershed 110 is collected in the public intake 120 associated with a water distribution system having piping elements 125 therein for distributing the water. A number of remote devices 130 can be positioned within the watershed 110 in order to evaluate the characteristics of the water prior to entering the water system and a number of remote units can be associated with a plurality of locations within the system enabling the tracking and evaluation of the water as it passes through the system. In addition, one or more remote devices can be positioned at the water outflow 160 in order to evaluate the quality of the water upon re-entering the environment. This type of configuration of the plurality of remote devices can provide a means for evaluating and determining locations of concern for water contamination or other desired or undesired characteristics of the water occur. Each of these remote units 130 are connected by a communication network 140 to a central controller 150, wherein this communication network can be the Internet, or other form of communication network, for example. The water outflow 160 defines the path by which the water passes out of the water distribution system back into the watershed 110. It would be readily understood by a worker skilled in the art that the water distribution system can equally be a natural gas distribution system or any other type of fluid distribution system for which there is a necessity to analyse the characteristics thereof. For example, if the analysis of a natural gas distribution system were required, the source would be a natural gas field instead of a watershed as would be readily understood.

Remote Devices

The fluid monitoring system according to the present invention comprises a plurality of remote devices that are remotely located and provide a means for analysing a fluid at desired locations and subsequently forwarding this information to the central controller. Operations performed by a remote device may include taking a sample of fluid, making a complete or partial spectral analysis of the fluid and sending the results to the central controller.

Each remote device comprises a sample chamber, a sensing system, a signal processing control system and a communication network system. The sample chamber provides a location in which the fluid to be analysed is placed or through which the fluid to be analysed flows. The sensing system is operatively associated with the sample chamber such that the sensing system is capable of illuminating the fluid in the sample chamber and is capable of detecting the response of the fluid to this illumination. The signal processing system provides a means for controlling the sensing system and hence controls both the illumination of the fluid and the detection of the response of the fluid sample. The signal processing system further comprises a weak signal detection module, which provides a means for detecting components of the spectral response of the fluid that can typically be masked by noise within the signal processing system and the sensing system. The communication network system may be integrated with the signal processing system or optionally as a separate module enabling communication between the central controller and the remote device through the use of a communication network. The networking system can be configured to enable a plurality of different networks to interconnect With the remote device, for example, PSTN, wireless, hardwired, Ethernet, Internet, local area network and the like. This type of interconnection with a communication network can enable the collection of information from a plurality of test sites by a central station, thereby potentially reducing the personnel required for the collection of this test data.

As would be known to a worker skilled in the art, depending on the communication system (LAN, WAN, Internet) by which the information from the optical systems is transmitted and the desired level of security desired for the information, varying levels of encryption of the data may be employed.

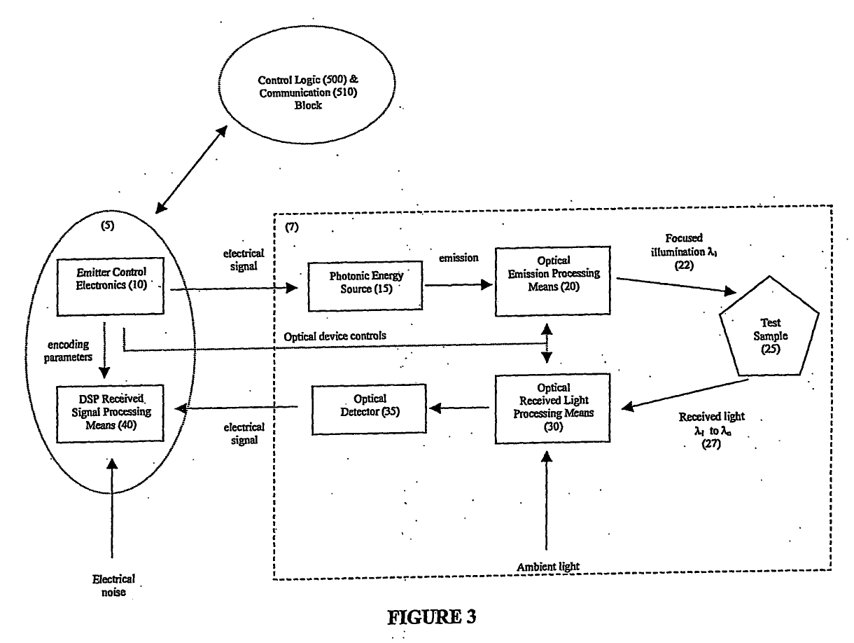

With reference to FIG. 3, the remote device according to one embodiment of the present invention comprising an optical sensing system 7 and a signal processing system 5. The remote device comprises: a photonic energy source 15 which is controlled by the signal processing system 5 (specifically the emitter control electronics 10), to emit electromagnetic radiation which can range from ultraviolet to far infrared (or a bandwidth from 100 nm to 20000 nm) and optical emission processing means 20 which is controlled by the signal processing system 5 (specifically the emitter control electronics 10) to receive light from the photonic energy source 15 and to deliver one or more illumination wavelengths 22 in an encoded format to a test sample 25. The optical emission processing means 20 can comprise a means for isolating one or more illumination wavelengths and emitter optics that orient and focus the illumination wavelength(s) onto the test sample 25. The remote device further comprises received light optical processing means 30 which is controlled by the signal processing system 5 (specifically the emitter control electronics 10) to collect and isolate one or more wavelengths of received light 27 due to the illumination of a test sample 25. The received light optical processing means 30 can comprise detector optics for collecting the received light from the test sample 25 and a means for isolating one or more of the wavelengths of the received light. Additionally, the system comprises an optical detector 35 to sense and convert to an electrical signal, the received light which has been transmitted by the received light optical processing means 30 and a DSP received signal processing means 40, which is a component of the signal processing system 5, to perform the matched correlation on the output of the optical detector 35. The matched correlation of the received signal is performed based on the received electrical signals from the optical detector 35 and encoding parameters from the emitter control electronics 10 used to encode the illumination wavelengths.

There are various locations for noise or interference to enter the signal processing system and the sensing system of the remote device according to the present invention, with this interference decreasing the ability to detect signals received from the test sample due to its illumination. For example and with further reference to FIG. 3, ambient light can enter the sensing system through the received light optical processing means 30 and electrical noise can enter the signal processing system through the DSP received signal processing means 40. The encoding of the illumination signal and the matched correlation of the received signal in relation to the encoded illumination signal can enable improved detection of the received signals resulting from the illumination of the test sample in the presence of noise or interference.

Signal Processing System

The signal processing system provides a means for controlling the sensing system and hence controls both the illumination of the fluid and the detection of the response of the fluid sample. The signal processing system further comprises a weak signal detection module, which provides a means for detecting components of the spectral response of the fluid that can typically be masked by noise within the signal processing system and the sensing system.

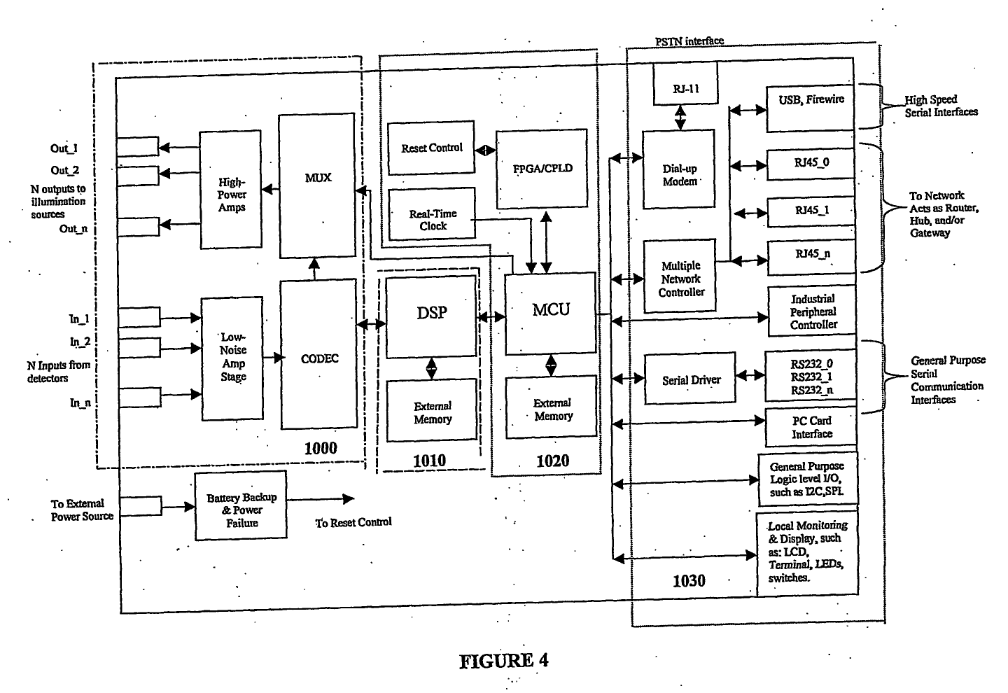

In one embodiment FIG. 4 illustrates a configuration of the signal processing system for integration into a remote device. The signal processing system comprises a DSP block 1010, a transmitter and receiver block 1000, a micro-controller (MCU) block 1020, a communication block 1030 and a digital and analog power supply block

In this embodiment the DSP block comprises a digital signal processing chip and an additional external static random access memory (SRAM). The DSP block performs the computation algorithms for fast, real-time processing of spectral data being transferred from the optical detector(s). This DSP block also generates signals that are capable of modulating the photonic energy source, wherein this modulation signal can be multiplexed to multiple photonic energy sources if required. However, each detector, if there is more than one, has a separate channel into the DSP block for the transmission of information relating to the received light. In addition, the DSP block can control a optical device that mechanically pulses the illumination radiation for encoding thereof, for example, a chopper. As would be known to a worker skilled in the art, the required processing speed of the DSP chip can be determined by the estimated amount and frequency of the incoming data that is to be processed, for example. In this manner an appropriate chip can be determined based on its processing speed, for example the number of Hertz that the DSP operates, 40 Hz, 60 Hz and so on.

According to this embodiment, the transmitter and receiver block comprises analog-to-digital converter(s) (ADC), digital-to-analog converter(s) (DAC) and low-pass filters, wherein these filters enable anti-aliasing of the received signal. If light emitting diodes (LEDs) or laser diodes are used as the photon energy source for the optical sensing system, this block may also comprise a multiplexer and high current amplifiers. The multiplexer enables the transmission of signals for the activation of the multiple photonic energy sources independently and the high current amplifiers provide a means for providing sufficient energy in order to activate these photonic energy sources such that their maximum spectral power output can be obtained. In one embodiment of the present invention, Texas Instruments's CODECs (coder/decoder), TLV320AIC20 and TLV320AIC10 are used as the analog to digital converters. In this example the TLV320AIC20 comprises two analog to digital converters and two digital to analog converters and the TLV320AIC10 comprises one analog to digital converter and one digital to analog converter. Thus by the incorporation of these two CODECs into the stand alone signal processing system; there is provided 3 independent input and output channels.

In this embodiment a communication block is integrated into the signal processing system and comprises a networking card, for example, an Ethernet chip or a wireless network chip, which enables the interconnection of the remote device to a communication network, for example a local area network WAN), a wide area network (WAN) or a wireless network (for example Bluetooth™ or IEEE 802.11). A worker skilled in the art would understand the format and type of chip or card that is required for the desired network connection. In addition the communication block further comprises a serial interface chip, for example a RS-232 port which can provide a serial interface to another component or system, for example a computer or a serial modem, for example dial-up or wireless type modem or a serial connection to a monochromator. The communication block therefore can provide a means for a computing system or a local computing system to access information collected by the signal processing system in addition to the amendment or replacement of algorithms that are operating on the signal processing system in addition to configuration data.

Furthermore, the micro-controller unit (MCU) block comprises a MCU chip, which may be an 8-bit, 16-bit or 32-bit chip, for example, an external SRAM and an external FLASH unit. The MCU block manages the DSP block and the communication block, wherein the MCU block collects processed data from the DSP block and forwards this information to the communication block. Optical devices that filter and/or focus the illumination and received light, for example light filters or monochromators, can be controlled by the MCU block. The MCU block may additionally performs statistical analyses on the data and may possibly activate an alarm setting. For example, an alarm setting may be activated if the level of fluorescence of the test sample exceeds a predetermined level, wherein this alarm activation may comprise the automated collecting of a sample for a more detailed analysis or the notification of personnel of the alarm activation. In the case where software updates to the DSP block are required, for example the modification of the match correlation procedure, the MCU block can manage the remote software updates of the DSP code, for example. The type of MCU chip incorporated into the MCU block may vary depending on the volume of information that is to be processed for example, as would be known to a worker skilled in the art. In one embodiment, the MCU chip has an interface enabling it to control two precision bi-polar DC motors, wherein the motor interface can be optically isolated from the pins of the MCU chip in order to limit the danger of damaging the MCU chip, for example. In another embodiment, the MCU chip can have a number of general output pins that can be used for controlling valves, temperature sensors and the like. In one embodiment, the programming of the MCU chip can be provided by an ISP interface which can be provided by the communication block as previously described. In a further embodiment of the invention, the MCU block further comprises a CPLD (complex programmable logic device) chip and a reset chip, wherein the CPLD is a re-programmable integrated circuit that contains address decoding logic and board reset logic.

The digital and analog power supply block of the signal processing system can provide regulated DC power at a variety of levels depending on that required by the components of the signal processing system. In one example, the input power to this system may be supplied by an unregulated or varying power supply, for example a wall plug. The digital and analog power supply block comprises elements that regulate the input power and subsequently generate the required analog and digital voltage levels for each component of the signal processing system. As examples, elements which enable the adjustment of the input power comprises transformers, AC-DC converters or any other power regulation element as would be known to a worker skilled in the art.

The signal processing system a variety of software operating thereon, wherein this is typically called firmware, which provides the signal processing system with its functionality. It would be readily understood to a worker skilled in the art that some of this firmware may or may not be present on any one configuration of the signal processing system, wherein required firmware can be determined based on the desired functionality of a particular signal processing system. For example, functionality of the firmware which can be running on the signal processing system can be selected from the group comprising: signal transmission and detection based on a desired coding function, for example BPSK principals; FIR filtering used to perform the initial clean up of the received coded pulses of photonic energy; autocorrelation to perform the secondary clean up of the received coded pulses; signal to noise estimation based on autocorrelation results; microcontroller/DSP communication interface software; microcontroller/serial port communication interface software; software drivers for the codecs; microcontroller's loading software designed to read a hex file and load the DSP ith its contents, for example instructions regarding its functionality; FPGA/CPLD software designed to create the glue-logic to interface the microcontroller, the multiple network controllers and the SRAM chips; microcontroller's driver enabling the operation of a dial-up modem.

A coding function is employed by the emitter control electronics in order to encode the illumination signal prior to interaction with the test sample, wherein this coding function can be provided by any number of signal modulation techniques. For example, pulse code software can be used to create a synchronous pulse for direct modulation of the signal control device frequency (pulse frequency modulation, PFM). With PFM the frequency of the pulses is modulated in order to encode the desired information. Pulse code software can be used to create a synchronous pulse for direct modulation of the signal control device amplitude (pulse amplitude modulation, PAM), wherein with PAM the amplitude of the pulses is modulated in order to encode the desired information. In addition, pulse code software can be used to create synchronous pulse for direct modulation of the signal control device pulse width (pulse width modulation, PWM). With PWM the width of the pulses is modulated in order to encode the desired modulation. Finally the illumination signal may be encoded using a function generator to create a fixed synchronous pulse enabling pulse rate and amplitude modulation, in addition to a mechanical encoder driver to create a synchronous pulse for an indirect signal modulator, for example a chopper, shutter, galvomirror etc.

In one embodiment of the invention the coding function that is employed by the emitter control electronics is binary phase shift keying (BPSK) which is a digital modulation format. BPSK is a modulation technique that can be extremely effective for the reception of weak signals. Using BPSK modulation, the phase of the carrier signal is shifted 180° in accordance with a digital bit stream. The digital coding scheme of BPSK is as follows, a “1” causes a phase transition of the carrier signal (180°) and a “0” does not produce a phase transition. Using this modulation technique a receiver performs a differentially coherent detection process in which the phase of each bit is compared to the phase of the preceding bit. Using BPSK modulation may produce an improved signal-to-noise advantage when compared to other modulation techniques, for example on-off keying. Other encoding techniques can be employed as would be readily understood by a worker skilled in the art.

Sample Chamber

The sample chamber provides a location in which the fluid to be analysed is placed or through which the fluid to be analysed flows. The sensing system is operatively associated with the sample chamber such that the sensing system is capable of illuminating the fluid in the sample chamber and, is capable of detecting the response of the fluid to this illumination.

In one embodiment of the present invention wherein the test sample is a flowing fluid, the sample chamber associated with the detection device may be a tube inserted and appropriately oriented within the fluid flow wherein this tube within the sample chamber provides a means for an optical probe to be oriented therein. For example, a flange at the end of the sample chamber could alternatively be used instead of a tube. In this example the optical probe performs the functions of the sensing system. This sample chamber can be designed such that it minimises the effects on the flow of the fluid thereby potentially reducing its affects on the detected response of the fluid to its illumination. The size, in particular the cross sectional area, of the sample chamber can be designed such that the surface area of the sample chamber is outside of the optical detector's field of view. In this manner, the detection of internal reflectance from the sample chamber may be minimised. In order to potentially further reduce the sample chamber's effect of the response, the surface area of the sample chamber can be fabricated with a non-reflective light absorbing material. Furthermore, in this embodiment, the sample chamber can be fabricated such that the optical probe can be removed for cleaning, if desired and subsequently replaced in the same orientation. A form of indexing may be used in order to facilitate the realignment of the optical probe upon replacement with in the sample chamber.

In another embodiment, the sample chamber is shaped to ensure the minimal amount of backscatter illumination towards the sensors associated with the sensing system. For example, an asymmetrical shape for the sample chamber can be used where the scatter off the sample chamber is substantially refocused and diffused towards the drain associated with the sample chamber, with no surfaces directly focusing the scattered light towards the sensors. In another embodiment, the shape of the sample chamber refocuses and diffuses the scattered illumination towards the vent. As would be readily understood, there are many other ways of shaping the sample chamber such that the scatted illumination is directed out of the sample chamber, while allowing the fluids to flow over the sensors.

In another embodiment of the invention, wherein the fluid to be evaluated is a liquid, the sample chamber is designed to maintain the pressure at a constant level in order to keep potential de-gassing from the fluid or at least to maintain such de-gassing as close to a constant as possible, thereby potentially limiting the affect this action has on the analysis performed by the remote device. Its configuration can be such that fluid enters a vertical stack, wherein gas rises to a vent at the top of the stack and fluid flow continues down to the sample chamber. The sample chamber may not have any line of site contact with the fluid input and vertical stack to reduce the interference of gas bubbles and potential boundary layers, vortices and interfering surfaces of different fluid quality mixes which could cause undesirable variations in the detection of the response of the fluid.

In one embodiment, the sample chamber is characterized as a chamber that allows fluid to flow through it and air to escape from above it. The optical sensors of the sensing system can be placed on the lower aspect of the sample chamber in order to provide a means that as much as possible air has been allowed to escape from above prior to coming into range of the sensors. Thus the systems associated with the sample chamber and the fluid transfer system, are used to reduce hydrodynamic noise. Additionally, a fluid exhaust channel may be positioned below the sensors in order to allow for the clearing of any particulate matter from the sample chamber after testing, for example. Furthermore, the fluid exhaust channel can be larger than the fluid intake in order to reduce the chances of the fluid exhaust channel becoming fouled.

Fluid Control System Associated with a Remote Device

The fluid control system associated with a remote device provides means for directing the fluid to be sampled through remote device while providing other features including suspended solid removal, fluid pressure reduction, system cleaning and sample extraction.

In one embodiment, the remote devices are designed to scan for, as much as possible dissolved particulate, thereby mitigating reflection noise from suspended solids within a fluid sample, from the detected spectral responses. In one embodiment, an intake filter can be used to remove coarse particles that might plug or otherwise reduce the flow of fluid into and through the remote device. A pump can be run continuously to ensure as much as possible, a continuous pressure for sampling procedures and to ensure air removal from the fluid. In one embodiment, the pump can be a submerged style of unit or could also be a suction/jet pump or other style of pump as would be readily understood.

In one embodiment of the invention, the fluid flows from the fluid distribution network into a first pressure-reducing valve (PRV) that acts to reduce any variations or surges m the fluid supply. This PRV can be positioned at the fluid intake of the remote device. The fluid subsequently flows to three areas, with these areas being the cleaning line, the sample capture line and the sample chamber fluid feed line, however these lines are not required to be separate wherein a single fluid feed line can be used to direct fluid to one or more of these required areas, namely cleaning, sample chamber and sample capture.

In one embodiment and having regard to the sample chamber feed line, the fluid is fed into a vertical stack associated with the sample chamber. In this case for example a second PRV can reduce the fluid pressure to a pressure predetermined for supply of the fluid into the sample chamber. This pressure drop can allow for gas bubbles to expand rapidly and be vented and to keep the pressure on the optics of the sensing system to below a desired level, for example, 20 psi, thereby potentially allowing for lower cost fittings due to the lower pressure, for example.

In one embodiment, having regard to the cleaning line, the fluid feeds directly to the internal or fluid sensing side face of the optics of the sensing system and is operated by an electronically actuated valve system to provide a high pressure fluid jet onto the face of the optics in order to provide a means for dislodging any particles that may have adhered to the optics. This action of causing a fluid jet to attempt to clean the optics can be controlled by the signal processing system, wherein the signal processing system can determine if parameters related to the collected information have altered in a manner that these types of readings are not consistent with the fluid being analyzed. For example, if the data indicates the changes in the collected information are not typical of the fluid type being examined. If there is a potential chance of a particle being adhered to the optical surfaces, a fluid jet steam can activated by a signal from the signal processing system through a relay and a signal of the correct power to match the valve actuator requirements can be sent. Fluid jets can also be actuated on a periodic basis in order to prevent build up on the surfaces. In one embodiment, there may be a chemically enhanced method of dislodging any biological film for example from the optics of the sensing system. For example, in a system used to measure water in a filtered water system one additive could be ozone, added by either pumping or by a venturi effect into the wash fluid. Another additive may be a combination of cleaners and descalers that would be used to decontaminate and remove any particulate matter from the optical surfaces. Another possible additive to the wash cycle is a fluorescent dye such as fluorescein, which may be used to calibrate the sensor responses and determine the performance levels of the equipment. Fluorescein can be mixed in a cleaning solution and when injected into the sensor chamber the equipment can calibrate its own performance characteristics.

In another embodiment a further fluid line feeds to an electronically actuated valve system that can automatically dispense a sample based on parameters set by the signal processing system. Sample collection and storage for biologically active samples must allow for samples to be maintained within a predetermined temperature range. This can be achieved by a cooling coil or by using a thermoelectric cooling device. When a high-risk event triggers a sample collection process, a valve can open allowing a sample to be dispensed from the fluid flow. The sample can be passed through the carbon filter or can be treated as required, and then dispensed into a sample capture chamber where it can be stored for additional processing by subsystems, treatment or can be dispensed into a bottle to be sent to a laboratory. A number of subsystems can be added to the sample collection system. This sample can be kept in the sample capture chamber where it is stored until dispensed by an operator, or it can be automatically discarded to a drain when the signal processing system determines it will collect a new sample, for example. The sample capture chamber can have a vent to allow for gas to escape upon the collection and this vent can also be connected to a drain, in order to discard the sample at a future date if required. The selection of a sample to be discarded can be based on age of the sample or other factors as would be readily understood. The sample collection process and subsystems are required to be used in systems where the need for automated sampling is required. In addition, for example, samples that are treated with chlorine in drinking water need to be dechlorinated by passing through carbon filters or through the addition of by chemical additives to neutralize the chlorine. One example of a commonly used chemical neutralizer is sodium thiosulfate. In another embodiment, there may be multiple sample capture chambers interconnected with a remote device, wherein the sample capture chambers can range in size, in addition to having a form of cooling apparatus associated therewith.

In a further embodiment, management of the system performance can also be achieved using a series of valves that are controlled by the MCU. Sensors can be used to measure pressure of the water coming into the system, wherein these pressure sensors can be indicators of pump performance in a self-reliant system, flow failure in a dependent, intake pressure, outlet pressure and pressure difference to measure potential fouling. The valves for flow control can be electronically operated, diaphragm, solenoid, or mechanical options available widely on the market. A peristaltic pump can also be used as a valve and as a pump.

In another embodiment, a subsystem for parasite filtering can automatically pass a volume of water through a collection filter so that parasites can be captured. The filter can be of an approved type for parasite collection and could be managed as required by the regulatory approved process. The filter apparatus can be maintained in a cooled chamber in order to ensure that these organisms are maintained in a live state prior to collection by an operator and subsequent testing.

Risk Reporting

In one embodiment, the remote device can monitor a fluid and can report data with an associated risk value for example to the central controller. Risk calculation metrics can be used in evaluating the duration, amplitude, frequency and phase of events. For example, in the case of biological turbidity in a water supply, the system can report the risk at any time, as a variable between for 1-9, where 1 would indicate no risk, and 9 would indicate a very high risk. This reporting can be presented in a weighted form where it can be compared to what is normal and the scale of reporting can be designed to be adaptive to the environment. For instance where events detected by a predetermined remote device at a predetermined location occur more often when compared with another device location, the frequency of events in normal operations can be recorded and used as a baseline, for example. An increase in the frequency of occurrence can increase the risk. Thus the total risk at a particular point in time might be reported as the same for two different remote devices even if the frequency of events occurring at these two locations is different.

In one embodiment, the risk can also be dependent upon the weighted value of responses. For instance, a sensor response from an input that only changes when there is a significant problem is likely to be given higher priority than a sensor that would respond to a wide variety of events. In addition, coincidental responses may cause a high level of risk. For example, a turbidity event might not be very significant if it contained very little biomatter, however when weighted by a significant biological event it would be more important. Furthermore, there may be more risk in a relatively small change at particular wavelengths that are related to biomatter than those related to non-organic dissolved solids, for example.

In one embodiment of the invention, the functionality of the signal processing system may further comprise the ability of establishing an alarm setting associated with the risk analysis for example, wherein one or more actions are taken upon the activation of an alarm setting. For example, the signal processing system may constantly correlate and perform statistical analyses on the processed data and once a predetermined level of change in the received light is reached, the signal processing system will activate the alarm setting. The activation of an alarm setting may result in a message being sent to the central controller. In one embodiment, wherein the test sample is a flowing fluid sample, the activation of an alarm setting can result in a fluid sample being extracted from the fluid flow, through the use of a valve to transfer fluid from the flow to a collection container, for example. This fluid sample may subsequently be subjected to a detailed analysis for evaluation of its contents at a laboratory, for example. In the example of the monitoring of a flowing fluid, the incorporation of an alarm setting may enable the capturing of significant changes in the fluid contents by the sampling of the fluid upon the detection of a particular level of change in fluid's reaction to light illumination. This procedure can provide an improved evaluation of the changes in a fluid's content as opposed to periodic, time based, sampling of the fluid.

Additional Sensors

In one embodiment of the present invention, additional sensors are incorporated into a remote device in order to determine additional qualities of the fluid sample being tested. For example a sensors including a pH sensor, a temperature sensor, a chlorine sensor or a turbidity sensor, for example. Other sensors can be incorporated into a remote device as would be known to a worker skilled in the art. These sensors can depend directly on the fluid being analysed, for example unwanted impurities in natural gas can be completely different from those in water and therefore the additional sensors associated with a remote device can be used to identify the desired impurities or contaminants of a particular fluid.

In one embodiment of the present invention, information collected by additional sensors associated with one or more of the remote devices, can be integrated into the risk analysis performed by a remote sensor, a cluster hub to which the remote device is connected or the central controller, thereby improving a risk analysis. For example, additional sensors for detecting parameters such as pH, chlorine, temperature and turbidity can be used as surrogate predicators of contamination events or of potential risk. In one instance, a change is temperature may change the ability of bacteria to reproduce, or a reduction of chlorine may reduce disinfection. Furthermore, if for example, a high degree of chlorine and a high degree of organic material has been detected, this may be suggestive of potential condition where trichloromethanes can be produced. As would be know to a worker skilled in the art, research has shown that this type of condition has been shown to be linked to an increased risk of cancer and therefore the detection thereof can be important.

Central Controller

The central controller associated with the system of the present invention can be used to monitor and further analyse information collected from the remote devices located at the remote locations and the cluster hubs, or regional controllers, if integrated into the fluid monitoring system. The central controller can be used as a database for the collected data and therefore can provide a centralised means for determining statistical analyses for the fluid distribution system if desired in order to evaluate trends and the like of the entire fluid system.

In one embodiment of the invention, the central controller server further comprises a database of the remote devices and cluster hubs wherein this database can comprise the specifications regarding location, access code, networking capabilities, communication network compatibility and any other parameter as would be known to a worker skilled in the art, thereby enabling the central controller to access each remote device or cluster hub to which it is connected.

In one embodiment, the central controller can send requests to the remote devices for additional data, such as more frequent testing, or to save a sample for example. In addition, the central server can be used to modify the parameters by which the remote devices perform the analyses. In this manner the central controller can transmit and/or amend the firmware associated with the signal processing system of the remote devices as would be known to a worker skilled in the art.

In one embodiment of the present invention, when the central controller determines that there is a level of risk within the fluid system being monitored, the central controller automatically is triggered to send alerts. These alerts can be sent by any medium, including email and mobile devices such as a cell phone. Typical triggers for alerts may include: system inactivity for more than 4 hours, determination of a high risk value, signal to noise ratio is outside the normal range, power values relating to collected data for different channels are weaker than normally collected and a sample of a fluid has been taken. Other triggers may be implemented based on different needs of various users of the fluid monitoring system and may be configured for particular users. Predetermined triggers can be sent automatically to a set of previously defined users, alerting them of potential problems.

In one embodiment of the present invention, the functionality of the central controller is provided by a single computing device, wherein the functionality of each component of the system is provided thereby, wherein the components of the system are embodied as computer programs executed by the computing device. In an alternate embodiment, the central controller may comprise a number of computing devices, wherein the functionality of the system is divided among a collection of computing devices. In this embodiment the appropriate computing program or programs which embody the one or more components of the system, are installed and executed on the appropriate computing device. A computing device that may be used in association with this invention may be for example a personal computer, a server computer, a main frame computer, or a combination thereof or any other type of computing device as would be known to a worker skilled in the art. In the case of multiple computing devices performing the functions of the central controller, suitable interface software and protocols are integrated thereon as would be readily understood by a worker skilled in the art.

Cluster Hubs

In one embodiment of the invention there may be regional central analysis servers that provide for the monitoring of a predetermined collection of detection devices. These regional central analysis servers can be interconnected together to a main central analysis server that only communicates with these regional servers in order to gather information. In this manner the collection and analysis of data can be performed on a tiered system and one particular central analysis server is not overloaded with the collection of all of the information collected for the plurality of detection devices.

Groups of remote units may be networked together in a cluster to be able to take advantage of changing conditions in a complex system and could be placed for instance in a variety of places such as a watershed, filtration and treatment centres, storage and distribution or within the operations of a single control centre such as a water purification facility. Detector clusters are capable of communication with each other as an intelligent community of sensors to allow for enhanced process management. These systems would also all link to a detector cluster hub and be capable of supporting a larger database for accumulating information that potentially includes health risk and environmental impact data. Sensors in a local network may be clustered to use one external communications hub to reduce costs.

Risk Analysis

In one embodiment, various portions of a risk analysis can take place at a remote device, the cluster hub and the central controller, wherein each stage becomes a more global fluid system analysis. Each unit can have defined rules that enable decisions to be made on the level of risk to be issued at each respective level. Risk can be determined from the measured values and rule-based criteria based on historical data. For example, the turbidity biomass or other multiple input metrics wilt vary, wherein remote devices can monitor this relationship on a continuous basis both using integrated intelligence, for example a rule based system applicable to the fluid being monitored and post monitoring. In one embodiment, the fluid monitoring system is more directed to value changes than with absolute values. As an example, risk can be reported as RBC, Risk of Biological Contamination as it can be representative of significant changes in a water system.

In one embodiment, the risk analysis can be a cluster analysis and related to the following, namely, evaluation of data from geospatially different locations, evaluation of data at the point of measurement having particular regard to the results from other sensors associated with the respective remote device and evaluation of data within a database enabling data mining. In this manner the risk analysis can provide a means for determining a level of risk for a particular area in a fluid system, a general risk for the entire fluid system and additionally is able to correlate and verity information collected from one remote device with a remote device in close proximity. For example, if a first remote device is positioned downstream of a second remote device, a contamination warning determined for the second location and not the first location, this scenario may prompt a more detailed analysis be performed at the first remote device that is down stream in an effort to collect additional information relating to the contamination. Secondly, correlation between results from a particular remote device and additional sensors connected thereto can provide a means for evaluating the performance of the remote device. And correlation between the detected information from a remote device with historical data can provide means for establishing trends for on a daily, weekly, monthly, or yearly basis for example, wherein historical events may occur after a predetermined level has been detected.

Risk can depend on a wide range of factors including the measurements taken, the variation with time of these values, the variation over the geographical space, the historical data, and the correlation between past measurements and problem levels of contaminants. An example of display of risk representation may be presented as an exponential representation of all of the inputs in a system. As an example, the distribution of events could show that a greater number of events, occur at a low risk level and that a low number of events could occur at a high-risk value.

According to one embodiment, FIG. 7 illustrates the relationship between the fundamental components involved in the computation of the risk value, and the generation of the database of information associated with the fluid monitoring system that can be associated with the central controller. All activities illustrated in FIG. 7 take place at the central controller, except for those specifically stated as being in the remote devices. The test area and test point configuration 520 can provide the overall configuration of the test area being monitored. This information can include the interrelationship between the test points. For example a water test point may be on a river down-stream of another test point, wherein this interrelationship between test points within a test area can be important to assist the modelling associated with a particular fluid system test area. Based on a particular test area, a determination is required for what would constitute a risk 530. Such risk could be, a certain level of pollution, whereby specific levels would relate to, for example, levels of pollution of drinking water, or a level of a chemical in a water wastage output from a manufacturing plant.

The Historical Database 500 of the measurements can provide the basis for a statistical dependency between the test points. The statistical analysis of the historical measurements 510 uses a mathematical model 540 to determine a time-based dependency between the measurement points, allowing a prediction from one state to another, in order that at any moment in time an accurate estimate may be made of the levels of, for example, pollution throughout the test area. As would be readily be understood, such a capability is important in enabling the prediction of future events which may result in the issuance of warnings of potential problems. Generally a vast array of test points requires a set of rules 560 to provide this form analysis. This set of rules allows processing of the data within a reasonable time. Using the predicted levels of particular pollutants, for example, and the risk values previously defined, alert levels can be determined, and sent to users via a variety of methods including email, cellphone or other media, wherein these alerts can allow a range of users to quickly understand a potentially problem situation. Additionally, a database specifically for access by users can allow the users to determine the different levels pollutions, for example, throughout the test area, together with existing and potential risk levels.

Simultaneously, the plurality of remote devices is continuing to provide more data to the central controller, wherein this additional data includes new data from regular testing, and risk alerts identified by a remote device. The central controller may have the capability of sending requests to the remote devices for additional data, such as more frequent testing, or to save a sample if the necessity has been determined during the analysis performed by the central controller. The central controller may also send new sets of rules to the remote devices for the calculation of risk alerts, if modifications thereto are determined to be required.

In one embodiment, the computations performed by the central controller occurring on the database for each node include checking system integrity, determining associations for computing a risk value, determining the necessary sampling parameters, and performing multimode analysis. Because the nodes collect multiple channels of data, multivariate analysis is required for each step in the computations.

In one embodiment, in order to ensure that system integrity has not deteriorated and remote devices do not require servicing, a variety of analyses can be conducted. These, analyses can be conducted for each of the remote devices, as well as the risk value provided thereby, to ensure system performance is at an acceptable level. The integrity-analysis can be conducted using historical data to determine daily, weekly, monthly and annual trends and behaviour. Tests used include basic descriptive statistics, short and long-term trend analysis and cyclic analysis. Should the results of the tests indicate poor remote device performance a maintenance check can be ordered.

In one embodiment, risk values can be used to represent the risk or danger in a fluid system based on multiple data inputs. Determining how to compute a risk value from the remote device can involve a thorough statistical analysis and classification process.

The methods needed for determining the data associations needed to calculate risk values from the data inputs involve a variety of statistical tests including Manova, T-tests, correlations, factor analysis; clutter analysis and regression analysis. These tests can be performed on the stored data for each remote device. The particular associations are slightly different for each remote device because each system performs slightly differently, and the interpretation of a “poor quality” sample may vary from site to site. The association of different inputs into the risk values changes with system integrity, so associations are checked on a regular basis, and the results are used to modify the way the DSP calculates the risk value.

In one embodiment, computations performed by the central controller can also be responsible for providing the signal processing system of one or more remote devices with a usable set of parameters to determine suitable sampling conditions, wherein this form of computation can comprise a statistical analysis of recent and long-term probability density functions for the systems data. Computing sampling parameters can require a combination of statistical methods including, analyzing and modelling distributions and analyzing basic descriptive statistics. The sampling parameters can be transmitted to the signal processing system for each node where they are used to determine when a sample should be taken. Parameters can be updated frequently so that, the sampling criteria is based on recent statistics, for example.

When multiple remote devices are present in the same watershed or other system, a multiple node analysis can be performed. Analyses can be performed to verify system performance, and enhance risk calculations. Analysis can be done on the risk values from the remote devices. Methods used for these calculations can include correlation, MANOVA, regression analysis, cluster analysis, factor analysis, and neural networks. Results from the analysis can be used to adjust the computation of sampling parameters and associations between risk and the data inputs.

The signal processing system for a remote device is responsible for several functions in addition to the fundamental signal correlation and processing algorithms necessary to properly measure the signal for each channel. With the central controller information provided to the signal processing system, calculations performed by the central controller and a relation mapping of the input data channels can be used to generate a risk value. The risk value can be calculated after data from each of the input channels has been updated. The risk value can be essential because it is used to determine whether samples should be taken. The signal processing system can employ functions that determine whether a sample should be taken or not. The decision can be based on a wide variety of factors including how recently a sample was taken, how high the risk value is the rate of change of the risk value, short and long term predicted signal behaviour based on trend analysis and seasonal and cyclic analysis.

While some of the factors above involve parameters calculated by the central controller, others are computed solely by the signal processing system associated with a remote device. The parameters used in the sampling decision scheme can come from two sources, one being the information provided by the central controller and the other being some simple calculations performed by the on-board signal processing system. Bandwidth limitations may prevent the transfer of all the raw data from each remote device to the central controller. Data can be transmitted regularly, so a combined smoothing and compression scheme designed to compress non relevant data, for example data indicating no significant change, in order to reduce the bandwith required for transmission. In this manner, a decrease in the bandwidth requirement is reduced, while not loosing information relating to significant changes in the fluid being monitored. Several schemes are available for this process, such as standard compression methods, polynomial interpolation and basic means, for example. Each method involves a different compression ratio and loss of data, however because of the frequency of data transmission the loss is tolerable.

In one embodiment, implementation of the risk analysis is achieved by following a set of specific actions. System integrity calculations are performed on a regular basis allowing daily data to be compared with data from similar periods of time in the historical database. Long-term trend and cyclic analysis of the data from each channel for the system are performed using Fourier analysis, and ARIMA to determine if there are any long-term trends present in the fluid system. The risk value can be intended to be a single meaningful value that accurately represents the risk inherent in the fluid passing through a remote device. The value can lie on a scale from 1 to 9, currently discrete values. A value of 1 is the minimum and 9 corresponds to the highest and most extreme risk. The risk value may be calculated through a cluster analysis algorithm. As an example, this enables 6 channels of data, 3 turbidity, 3 fluorescent, for example to be combined into a single variable. The cluster analysis scheme builds a meaningful classification of the different possible inputs into the risk value. The clustering for each remote device will be slightly different, this is necessary because there will be slightly different behaviour among the different remote devices, and what may qualify as an extreme signal at one remote device may be routine in another. The necessary sampling parameters can be calculated assuming recent historical data is a Gaussian distribution, the distribution parameters are calculated (mean, variance, etc.) and the sampling parameters can be obtained using the fact that for a Gaussian distribution, a known percentage of measurements lie within each deviation from the mean. This allows for the determination of a threshold value such that only a small percentage of all measurements fall above it, and hence only the most extreme readings will trigger the remote device to sample, provided the additional checks performed on the remote device are satisfied, for example. A neural network can be used to draw meaningful conclusions from multiple remote devices in the same systems. The results can be used to verify system integrity, to analyze the risk calculations and can be incorporated into the calculations.

In another embodiment of the risk analysis, the signal processing system calculates the risk value based on a classification scheme determined through the database computations. The parameters of the particular relationships and clusters identified by the cluster analysis algorithm scheme are updated on a regular basis via communications from the central controller to each remote device. The analysis algorithm run on the central controller can generate a set of relations between the data inputs that can be used to express the data in a single risk variable. The decision scheme can be used to determine when to analyse a combination of factors including the rate of risk increase, concavity of the risk signal, sampling parameters from the central controller computations; how recently the sample was taken and short and long term trends. For each factor considered, a threshold value can be provided, for example calculated by the signal processing system of a remote device or provided by the central controller calculations. Should the thresholds for a given condition be exceeded, and a sample has not been taken recently, a new sample can be taken.

The multiple channels collecting raw data need to store it in a form that is readily communicable to the central controller due to bandwidth limitations. To accomplish this a polynomial interpolation is used. Data from each channel is represented by the four coefficients for the data collected in the channel. A mean square error is also stored, giving an indication of the quality of the fit. Each point in the fit has equal weight.

For example, there are many possible reasons for the response characteristics of the fluid system that will depend on the location of the individual remote device and its fluid characteristics. The output of many different biomolecules likely to be responsive to multi-spectral analysis can be characterised, by examining patterns of the reflective and fluorescent emissions. This type of analysis can be helpful in removing the effects of optical noise from interfering biomolecules such as chlorophyll. By searching for the optical emission of specific peaks and comparing the relative frequency, amplitude and duration of events, a relationship of patterns in a continuously variable stream of matter can be determined. The change in these patterns can be a key factor in determining risk. Further, the relationship of differences from individual remote devices throughout a network can be used to determine the total risk in an entire fluid system. As sensors that depend on light spectroscopy as used in an on-line system are generally not specific in nature due to potential spectral interferences and as a result cannot be used to identify a specific pathogen, the patterns of change can become more important than the absolute response from any one remote device. The relative patterns that such remote devices record can become more useful than their absolute response at any one time.

An example of this consideration is the relatively high level of fluorescence that results from chlorophyll. As such the presence of chlorophyll can dominate some detection wavelengths, thus making the system less sensitive to bacterial contamination than other wavelengths. This type of situation would typically be recorded in a received illumination pattern as, a higher consistent background or longer event periods but because the effect of chlorophyll can be measured and accounted for, contamination risk can be weighted to measurement channels that are not affected by chlorophyll. This technique could apply to any contaminant that had measurable features and the weighting of responses from various sensors is an important feature for real time signal processing and risk determination. In the case where chlorophyll is expected to become an interfering factor, more measured wavelengths can be dedicated to measuring its spectral peaks to determine how its total presence may change with respect to other factors. In such a case, the variations at other wavelengths may take on more importance. These functions can automatically account for the response in the real time systems intelligence. By creating a rule based system that accounts for response patterns, remote devices may be capable of responding to simple questions that may be posed, for example “What organisms are causing the changes in the water?”

Risk is calculated in real time, based on event basis without performing a high specificity assay. A pathogen or total risk fluid audit at each site which would provide the biological and chemical review of general fluid quality, and when a rule-based system was asked, “What characteristics have changed, when and by how much?”, the remote device can automatically apply a risk value based on the probability of contamination. It is on this basis that remote devices can determine when to take a sample and the rule-based system determines the risk at any one point in time. It is the risk value that determines if a sample is to be collected and stored or sent to the lab and how it is to be prioritised in the overall events schedule.

External Interface to the System

In one embodiment, the fluid monitoring system includes appropriate interfaces for access to the information within the system by authorized personnel. For example there can be two types of interfaces available, for example a message alert that can be sent to a user to warn of a problem or potential problem and secondly an interface providing a user access to a database of information in order to provide a more detailed outlook of the parameters detected within the fluid system being monitored.

A user requiring information from the database may with appropriate authority and passwords, access part of the database. FIG. 8 shows a representation of the interface system. Generally the user will employ the Internet to access the database via a firewall to view recent and historical data, trends, alert messages, alert criteria and any other relevant and authorized information. This access is an important aspect of the system allowing many people to have access to processed data relevant to their own particular area of interest. The system has the capability, for example to allow questions, responses and general communication.

As would be known to worker skilled in the art, while this description is directed towards the collection of information relating to the analysis of water, the system according to the present invention can equally be used for the remote analysis of a plurality of other fluids for example, air within a HVAC system, gas or oil within a pipeline system, or the like. A worker skilled in the art would fully understand the modifications that would be required in order to enable the analysis of other fluids, for example the modification of the illumination wavelengths in order to enable a desired analysis of the fluid that is under consideration.

### EXAMPLE

### Remote Device Testing Procedure

As an example, the following defines the potential optical analyses that can be performed using remote device incorporated into the fluid monitoring system according to the present invention, wherein these analyses are specific to water being the fluid being monitored. For example, the detection of turbidity in water can be based on APHA AWWA WEF physical and aggregate properties method 2130.B nephelometric and ISO. Turbidity can be a reliable method to determine the total concentration of dissolved solids in a continuous manner wherein this can be determined based on the collection of reflectance data from the water sample. In one embodiment turbidity can be measured at 590 nm and 840 nm and the illumination emitters can be high performance LED's and the optical emissions can be dispersed from the emitter lens at about 20°. The optical detector can view the emitted light path or the optical normal at a fixed angle such as 60°. For example the detection of bio-fluorescence turbidity can be based on APHA AWWA WEP physical and aggregate properties method 2130 B nephelometric. To baseline biological examination for example, method can be used in the laboratory such as for chlorophyll including 10200 H chlorophyll, US EPA NERL Method 445.0. Fluorescent turbidity can be used as a method to measure a surrogate of the total concentration of dissolved bio matter in a continuous manner, wherein this can be based on the detection of fluorescence data from the water sample. In one, embodiment, two channels of bio fluorescence can be used to characterise the water flow. The two emitters can be high performance LED's and the optical emissions can be. dispersed from the emitter lens at about 20°. The optical detector can view the emitted light path or the optical normal at a fixed angle such as 60°, for example. In one embodiment, long pass filters can be placed in front of the two optical detectors. Two channels of turbidity can be measured in with the first emitter at 470 nm and a long pass filter over the detector optimised for 590 nm and the second emitter at 590 nm and a long pass filter optimised for 640 nm.

The remote detector units are not designed to yield laboratory standard measurements but rather a time dependent reference standard documenting what has occurred, what is happening and what is likely to be happening at each sensor and each sensor group. However, the ability to gather information in the same manner as accepted by existing standards is also a key feature. The ability to duplicate standard laboratory measurements in the field is generally subject to the field conditions in which such systems operate. As a result there are opportunities to improve systems performance and design.

The remote detector units are designed to be similar to laboratory standard nephelometers, but with performance capabilities to reduce background interference and noise such as those problems which might be encountered with standard turbidity monitors including, bio-fouling, physical fouling, hydrodynamic noise and bubbles, direct interference from heat, radiation and vibration, electronic interference and calibration drift. Additionally, remote detector subsystems are designed to help perform calibrations and maintenance as well as also automatically engaging in some laboratory operations such as sample collection and preparation.

In an example the case of using off the shelf LED emitters, the filters for excitation and emission could be as listed below in Table 1, wherein this table indicates a variety of spectral characteristics and some of their most likely causes from a bio-spectroscopy point of view. The columns labelled Channel 0 and Channel 1 provide the filter characteristics of the detector.

TABLE 1

| | Excitation band | Channel 0 | Channel 1 |
|---|---|---|---|
| Detector | | Filters: | Filters: |
| | | 0 Yellow 510 nm high pass | 1 Red 610 nm high pass |
| | | 2 Visible 440 nm high pass | |
| TX S | UV | NADH 430 nm | NA |
| | 320 nm-370 nm | (Ch 2) | |
| TX 0 | Yellow | Bio turbidity | Cyanobacteria 620 nm |
| | 540 nm-600 nm | Absorption and Reflection | Fluorescence |
| | | | Cytochrome 630 nm |
| | | | Fluorescence |
| TX 1 | NIR | Turbidity | Turbidity correction |
| | 840 nm-920 nm | NTU reference standard | reference |
| | | | Chlorophyll absorption |
| | | | peak1 μm |
| TX 2 | Blue | Flavins 550 nm Fluorescence | Cytochrome 630 nm |
| | 440 nm-500 nm | FAD 530 nm Fluorescence | Fluorescence |
| | | Chlorophyll 530 nm | |
| | | Fluorescence | |

For example, the photonic energy source can be configured with a number of options to be wavelength specific or wave band specific depending upon the perceived risks and what type of bio-matter the systems are checking for. For example LED emitters using white light can be broken into various bands or wavelengths and if more specificity is required, the system can be optimized with band specific LED's (such as a blue LED) or a wavelength specific laser diode. Further optical conditioning can be achieved with lens systems to reduce stray light or improve collimation and can also be combined with optical band pass or interference filters to give greater frequency specificity and to reduce out of band chromatic diffraction noise. The LED emitters are typically waterproof and sealed behind an optical window in the same manner as the sensors.

The relationship between sensors and emitters is configured in accordance with a classic nephelometer as defined to ISO standards so that the optical measurement performance can be compared directly to classical turbidity measurements.

The embodiments of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

We claim:

1. A system enabling remote analysis of a fluid, said fluid being collected from at least one source, said system comprising:
a) a plurality of remote devices capable of collecting and analyzing the fluid, each said remote device including:
i) a sample chamber for receiving and orienting the fluid for analysis, said sample chamber being in fluidic contact with one at least one source;
ii) a sensing system operatively associated with the sample chamber, said sensing system illuminating the fluid with an encoded illumination signal and collecting an illumination response;
iii) a signal processing system for controlling the sensing system, said signal processing system performing data analysis procedures for detecting and correlating the illumination response with the encoded illumination signal, thereby providing a means for determining a fluid spectral response to the illumination of the fluid; and
iv) a communication module, enabling the remote device to transmit signals;
b) a central controller for receiving signals from the plurality of remote devices, said signals including a plurality of fluid spectral responses, the central controller collecting the signals for subsequent analysis; and
c) at least one communication network enabling transmission of signals between the plurality of remote devices and the central server.

2. The system enabling remote analysis of a fluid, according to claim 1, said central controller further comprising a risk module for determining a risk assessment, said risk assessment based on the signals from the plurality of remote devices.

3. The system enabling remote analysis of a fluid, according to claim 1, wherein one or more of the plurality of remote devices comprises one or more additional sensors interconnected thereto for measuring additional conditions of the fluid, said additional sensors selected from the group comprising a pH sensor, a temperature sensor, a chlorine sensor and a turbidity sensor.

4. The system enabling remote analysis of a fluid according to claim 3, said central controller further comprising a risk module for determining a risk assessment, said risk assessment based on the signals from the plurality of remote devices and information collected by the one or more additional sensors.

5. The system enabling remote analysis of a fluid according to claim 1, further comprising one or more cluster hubs intermediate between one or more of the plurality of remote devices and the central controller, said one or more cluster hubs in communication contact with the one or more of the plurality of remote device and the central controller, said one or more cluster hub providing a means for collection, organisation and optionally compression of the signals from the one or more remote devices prior to transmission of the signals to the central controller.

6. The system enabling remote analysis of a fluid according to claim 5, wherein said one or more cluster hubs further comprise a risk module for determining a risk assessment, said risk assessment based on the signals from one or more of the plurality of remote devices.

7. The system enabling remote analysis of fluid according to claim 1, wherein the plurality of remote devices further comprise a risk module operating thereon, said risk module providing a means for evaluating predetermined criteria of the fluid at a remote location.

8. The system enabling remote analysis of a fluid according to claim 2, wherein the risk model is selected from the group comprising Manova, T-tests, regression analysis, correlation analysis, factor analysis and cluster analysis.

9. The system enabling remote analysis of a fluid according to claim 1, wherein one or more of the plurality of remote devices further comprises a means for test sample collection, wherein test sample collection can be activated by the central controller, a cluster hub or the remote device.

10. The system enabling remote analysis of a fluid according to claim 9, wherein the test sample is maintained at a predetermined temperature until collection of the test sample by a technician.

11. The system enabling remote analysis of a fluid according to claim 1, wherein the central controller or one or more of the plurality of remote devices activates an alarm setting upon detection of predetermined characteristics in the fluid.

12. The system enabling remote analysis of a fluid according to claim 1, said encoded signal being encoded by an encoding means selected from the group comprising pulse frequency modulation, pulse amplitude modulation, pulse width modulation, binary phase shift keying or a mechanical encoder.

13. The system enabling remote analysis of fluid according to claim 1, said remote device further comprising a means for suspended solid removal from the fluid prior to entry into the sample chamber.

14. The system enabling remote analysis, of fluid according to claim 5, said central controller or said one or more cluster hubs correlating signals from each of the plurality of remote devices to determine current status of operations of each remote device.

15. The system enabling remote analysis of a fluid according to claim 2, wherein said remote module is capable of accessing an historical database during risk evaluation, said historical database providing a means for establishing a baseline for the risk evaluation.

16. The system enabling remote analysis of a fluid according to claim 1, wherein said at least one communication network is selected from the group comprising wireless, wired, Ethernet, WAP, PSTN and satellite.
